(19) United States
(12) Patent Application Publication
(10) Pub. No.: US 2022/0414858 A1
(43) Pub. Date: Dec. 29, 2022

(54) METHOD FOR DETERMINING WIRE REGIONS OF A CIRCUIT

(71) Applicant: V5 TECHNOLOGIES CO., LTD., Hsinchu City (TW)

(72) Inventors: Sheng-Chih HSU, Hsinchu City (TW); Chien-Ting CHEN, Hsinchu City (TW)

(73) Assignee: V5 TECHNOLOGIES CO., LTD., Hsinchu City (TW)

(21) Appl. No.: 17/305,040

(22) Filed: Jun. 29, 2021

(51) Int. Cl. G06T 7/00; G06T 5/30; G06T 5/00; G06T 7/60; G06T 7/70; G06K 9/20

(52) U.S. Cl. CPC G06T 7/0004; G06T 5/30; G06T 5/005; G06T 7/60; G06T 7/70; G06K 9/2054; G06T 2207/30141

(57) ABSTRACT

A method for determining wire regions of a circuit includes steps of: obtaining an original image containing multiple stick regions; processing the original image to obtain a first processed image containing multiple line segments; grouping the line segments into multiple groups corresponding respectively to the stick regions; generating a second processed image including multiple complete lines corresponding respectively to the groups; and generating a third processed image including multiple extended lines by extending the complete lines; and determining, for each of the extended lines in the third processed image, a rectangular region based on a stick region in the original image corresponding thereto.

### FIELD

The disclosure relates to a method for determining wire regions of a circuit.

### BACKGROUND

Defect detection of a circuit product, for example, a semiconductor circuit, utilizes masks with respect to different components of the circuit product. For example, the masks may include a mask for wires, a mask for input/output holes and a mask for integrated circuits (ICs). A conventional mask for wires disposed on a circuit product reveals all wires on the circuit. That is, the wires on the circuit have to be inspected all at once, and cannot be inspected individually. Therefore, there is a downside in using the conventional mask to inspect wires.

### SUMMARY

An object of the disclosure is to provide a method for determining individual wire regions of a circuit that includes multiple wires, wherein the wire regions thus determined correspond to the wires respectively. The wire regions determined by the method may be utilized to generate masks respectively for the individual wires, and the masks may be utilized to inspect the wires individually. Using a mask dedicated for an individual wire to inspect the wire may increase precision of defect detection, and may reduce computational complexity. Therefore, the disclosed method alleviates at least one of the drawbacks of the prior art.

According to one aspect of the disclosure, the method includes steps of: obtaining an original image that is a binary image and that contains multiple stick regions having a first pixel value and corresponding respectively to multiple wires of a layout of a circuit; processing the original image to obtain a first processed image that is a binary image and that contains multiple line segments having the first pixel value and being obtained from the stick regions; based on distances and included angles among the line segments, grouping the line segments into multiple groups that correspond respectively to the stick regions in the original image; generating a second processed image based on the first processed image, the second processed image being a binary image and including multiple complete lines that have the first pixel value and that correspond respectively to the groups and respectively to the stick regions in the original image, each of the complete lines being constructed by integrating the line segments of the respective one of the groups into the complete line; generating a third processed image by extending the complete lines in the second processed image based respectively on the stick regions in the original image, the third processed image being a binary image and including multiple extended lines which have the first pixel value, which correspond respectively to the stick regions in the original image, and each of which has a length equal to a length of the corresponding one of the stick regions; and for each of the extended lines in the third processed image, determining a rectangular region in the third processed image that covers the extended line, that has a length equal to the length of the extended line, and that has a width which is determined based on the corresponding one of the stick regions in the original image.

### BRIEF DESCRIPTION OF THE DRAWINGS

Other features and advantages of the disclosure will become apparent in the following detailed description of the embodiment (s) with reference to the accompanying drawings, of which:

FIG. 1 is a flow chart that exemplarily illustrates a method for determining wire regions according to an embodiment of the disclosure;

FIG. 2 is a schematic view that exemplarily illustrates an original image representing a mask for multiple wires of a layout of a circuit according to an embodiment of the disclosure;

FIG. 3 is a flow chart that exemplarily illustrates sub-steps of Step 102 of the method shown in FIG. 1 according to an embodiment of the disclosure;

FIG. 4 is a schematic view that exemplarily illustrates a simplified image obtained from the original image according to an embodiment of the disclosure;

FIG. 5 is a schematic view that exemplarily illustrates a first processed image obtained from the simplified image according to an embodiment of the disclosure;

FIG. 6 is a flow chart that exemplarily illustrates sub-steps of Step 103 of the method shown in FIG. 1 according to an embodiment of the disclosure;

FIG. 7 is a schematic view that exemplarily illustrates a second processed image obtained from the first processed image according to an embodiment of the disclosure;

FIG. 8 is a flow chart that exemplarily illustrates sub-steps of Step 105 of the method shown in FIG. 1 according to an embodiment of the disclosure;

FIG. 9 is a schematic view that exemplarily illustrates rectangular regions in a third processed image according to an embodiment of the disclosure;

FIG. 10 is a flow chart that exemplarily illustrates a first implementation of Step 106 of the method shown in FIG. 1 according to an embodiment of the disclosure;

FIG. 11 is a flow chart that exemplarily illustrates a second implementation of Step 106 of the method shown in FIG. 1 according to an embodiment of the disclosure;

FIG. 12 is a flow chart that exemplarily illustrates a third implementation of Step 106 of the method shown in FIG. 1 according to an embodiment of the disclosure; and

FIG. 13 is a flow chart that exemplarily illustrates a modification of the method of FIG. 1 according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

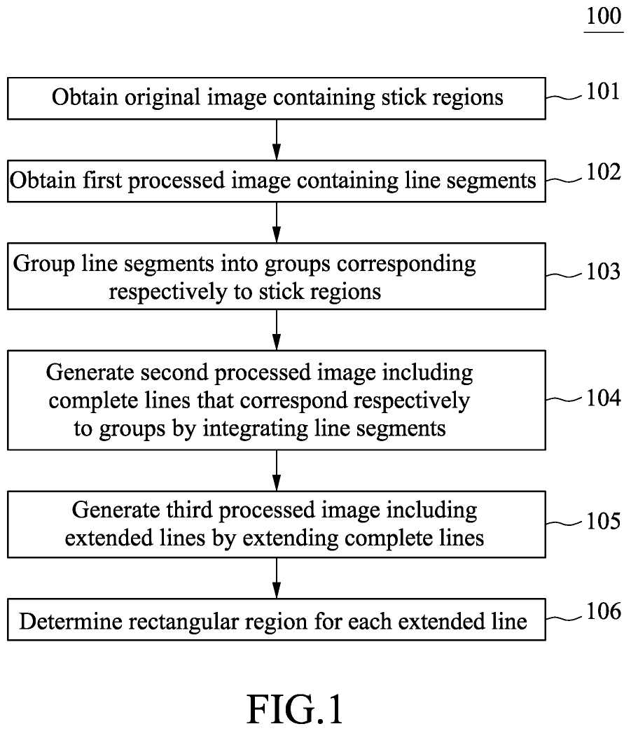

FIG. 1 exemplarily illustrates a method 100 for determining wire regions of a circuit according to an embodiment of the disclosure. For example, the circuit may be a semiconductor circuit, but the disclosure is not limited thereto. The method 100 includes Steps 101 to 106. According to some embodiments, the method 100 may be performed by a computing system (e.g., a personal computer, a server, a workstation, etc.) that includes at least one processor and memory storing program instructions which, when executed by the at least one processor, cause the at least one processor to implement the method 100.

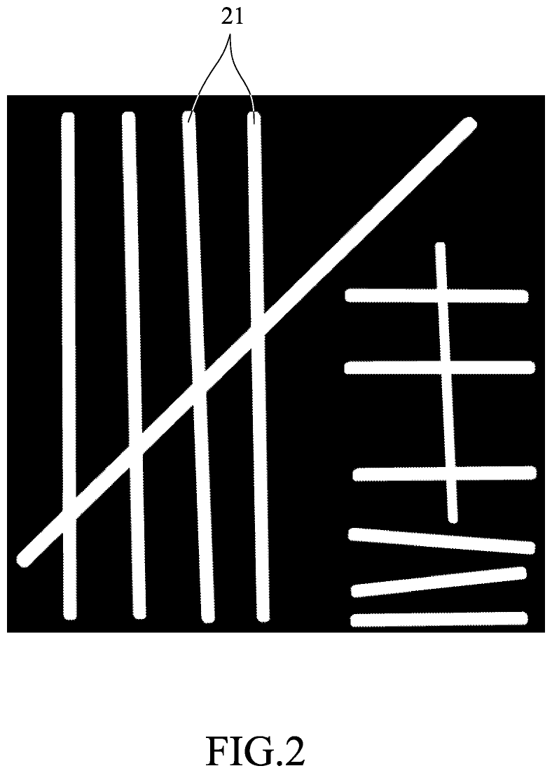

Step 101 is to obtain a binary image (referred to as “original image” hereinafter) that represents a mask for multiple wires of a layout of the circuit. The original image contains multiple stick regions that have a first pixel value and that correspond respectively to the multiple wires. The rest of the original image excluding the stick regions has a second pixel value that is different from the first pixel value. An example original image thus obtained is schematically illustrated in FIG. 2. The original image shown in FIG. 2 contains twelve stick regions 21 that are colored white by having a pixel value of 255 (the first pixel value), and the rest of the original image is colored black by having a pixel value of 0 (the second pixel value). In an embodiment, the original image is obtained based on a schematic diagram that is provided by a designer of the circuit and that distinguishes wires from other components on the layout by using different colors or grayscales. In some other embodiments, the original image is obtained by manually marking out regions occupied by the wires on an image or a photograph of the circuit. However, approaches for obtaining the original image are not limited to said embodiments.

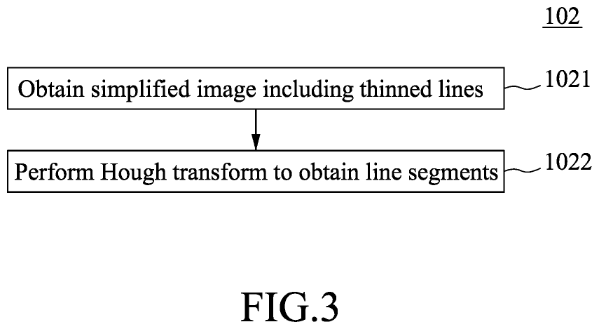

Step 102 is to process the original image to obtain a first processed image that is also a binary image and that contains multiple line segments. The line segments have the first pixel value, and are obtained from the stick regions. According to an embodiment, Step 102 may include Sub-steps 1021 and 1022 as illustrated in FIG. 3.

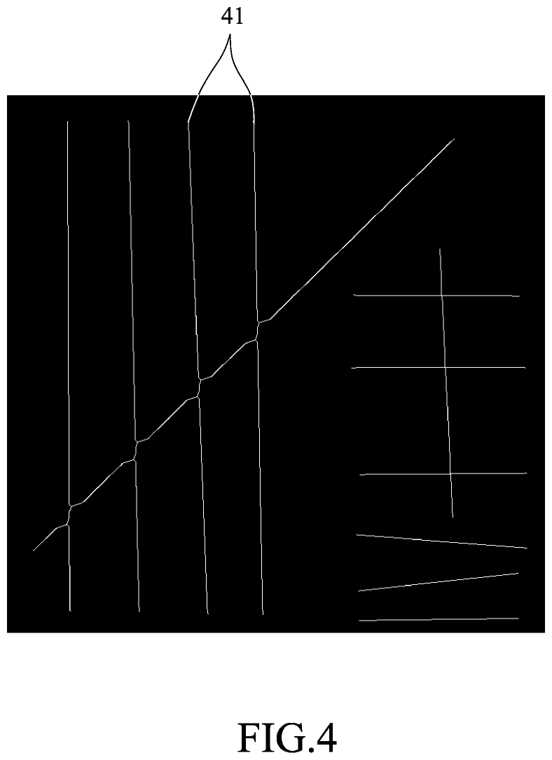

Referring to FIG. 3, Sub-step 1021 is to perform image thinning on the original image to obtain a simplified image that includes a plurality of thinned lines. The thinned lines are obtained from reducing widths of the stick regions of the original image, respectively. An example of the simplified image is schematically illustrated in FIG. 4. The simplified image illustrated in FIG. 4 is obtained from the original image illustrated in FIG. 2, and contains twelve rough lines 41 (i.e., thinned lines) that respectively correspond to the twelve stick regions 21 of said original image of FIG. 2. As shown in FIG. 4, some of the thinned lines 41 may have several undesired bends while the stick regions 21 are all straight. According to some embodiments of the disclosure, Sub-step 1021 may be implemented by using known image thinning algorithms such as a fast parallel algorithm for thinning digital patterns.

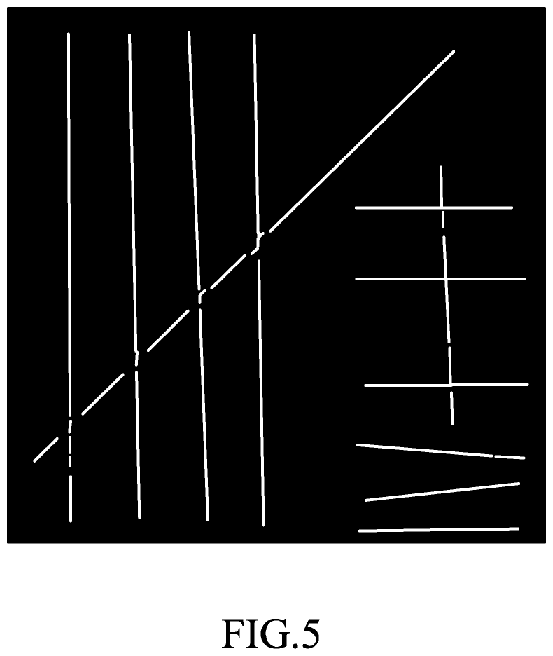

Next, Sub-step 1022 is to perform Hough transform on the simplified image to obtain the line segments, so as to obtain the first processed image. Hough transform is a known feature extraction technique that may detect and extract lines or line segments in an image. According to some embodiments of the disclosure, short line segments that are shorter than a length threshold are considered noises, and are ignored when performing Hough transform. Therefore, the first processed image thus obtained would not contain any line segment that is shorter than the length threshold, and some of the thinned lines may be broken into the line segments. In an embodiment, the length threshold is 5 pixels, but the disclosure is not limited thereto. Ignoring the short line segments may be implemented by manipulating settings of a Hough transform algorithm that is used. An example of the first processed image is schematically illustrated in FIG. 5. The first processed image illustrated in FIG. 5 is obtained from the simplified image illustrated in FIG. 4, and contains one hundred and seventeen line segments 51 that correspond to the twelve thinned lines 41 of said simplified image.

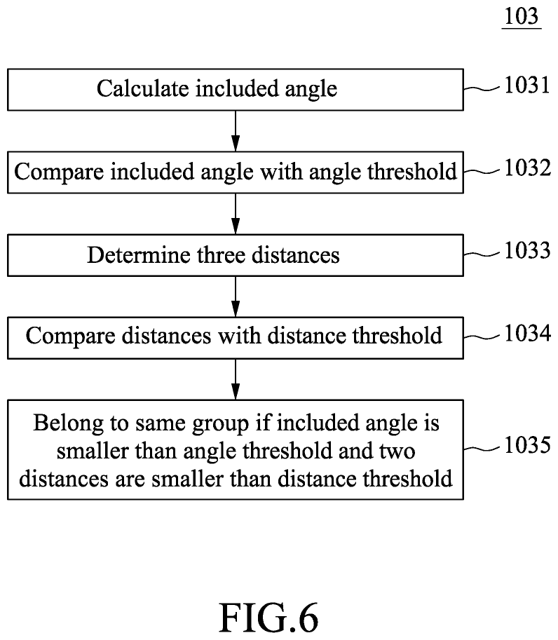

Returning to FIG. 1, Step 103 that follows Step 102 is to group the line segments of the first processed image into multiple groups based on distances and included angles among the line segments, where the groups correspond respectively to the stick regions in the original image. That is to say, the line segments obtained from the same stick region are put into the same group. Basically, two line segments that are close to each other and that have similar orientations would be considered as belonging to a same line and thus belonging to a same group. According to an embodiment, Step 103 may include Sub-steps 1031 to 1035 as illustrated in FIG. 6 that are to be performed with respect to each different pair of the line segments that includes a first line segment and a second line segment.

Referring to FIG. 6, Sub-step 1031 is to calculate an included angle between the first line segment and the second line segment, which is the included angle between two lines defined respectively by extending the first line segment and the second line segment.

Sub-step 1032 is to compare the included angle with an angle threshold that may be, for example, 10 degrees.

Sub-step 1033 is to determine three distances that are respectively between three points on the first line segment and the line defined by the second line segment. The three distances include a first distance between a first end point of the first line segment and said line, a second distance between a second end point (i.e., the other end point) of the first line segment and said line, and a third distance between a center point of the first line segment and said line.

Sub-step 1034 is to compare each of the first distance, the second distance and the third distance with a distance threshold that may be, for example, 10 pixels.

Sub-step 1035 is to determine that the first line segment and the second line segment belong to a same group when the included angle obtained in Sub-step 1031 is smaller than the angle threshold and any two of the first distance, the second distance and the third distance obtained in Sub-step 1033 are smaller than the distance threshold.

It should be noted that Sub-steps 1031 and 1032 need not be performed before Sub-steps 1033 and 1034 as illustrated in FIG. 6. According to some embodiments, Sub-step 1031 may be performed after or simultaneously with Sub-step 1033, Sub-step 1032 may be performed any time after Sub-step 1031 and before Sub-step 1035, and Sub-step 1034 may be performed any time after Sub-step 1033 and before Sub-step 1035.

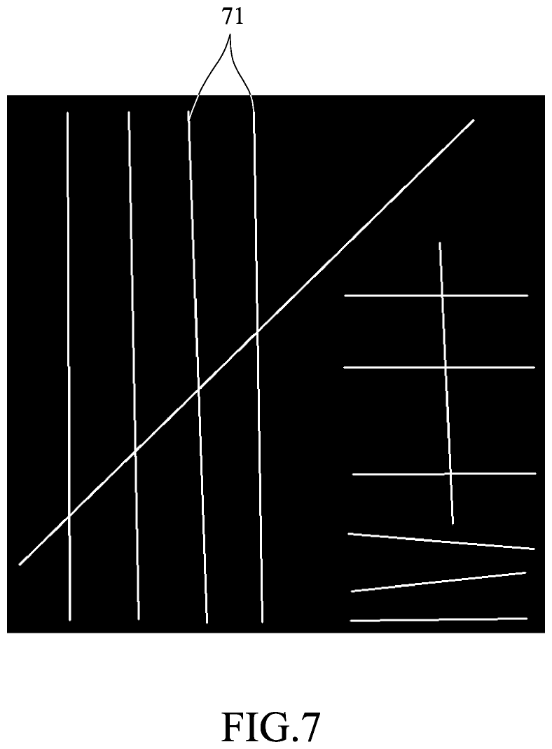

Returning to FIG. 1, Step 104 that follows Step 103 is to generate a second processed image that is also a binary image based on the first processed image. The second processed image includes multiple complete lines that correspond respectively to the groups determined in Step 103 (and thus correspond respectively to the stick regions in the original image), and that are each constructed by integrating the line segments of the respective group into the complete line. The complete lines in the second processed image have the first pixel value, and the rest of the second processed image has the second pixel value. An example of the second processed image is schematically illustrated in FIG. 7. The second processed image illustrated in FIG. 7 is obtained from the first processed image illustrated in FIG. 5, and contains twelve complete lines 71 corresponding respectively to the twelve stick regions 21 of the original image of FIG. 2.

According to some embodiments of the disclosure, Step 104 may include four sub-steps (i.e., first to fourth sub-steps) that are to be performed with respect to each different pair of the line segments that are determined to be of the same group and that include a first segment and a second segment. The first sub-step is to, for each of the first and second segments in the pair, find or locate two opposite end points of the line segment (referred to as “first end point” and “second end point” hereinafter). The second sub-step is to calculate six distances related to the first and second segments. The six distances include a distance between the first and second end points of the first segment, a distance between the first end point of the first segment and the first end point of the second segment, a distance between the first end point of the first segment and the second end point of the second segment, a distance between the second end point of the first segment and the first end point of the second segment, a distance between the second end point of the first segment and the second end point of the second segment, and a distance between the first and second end points of the second segment. The third sub-step is to determine a greatest one of the six distances and two of the first end points and the second end points that correspond to the greatest one of the six distances. The fourth sub-steps is to integrate the first and second segments based on the two of the first end points and the second end points that are determined in the third sub-step.

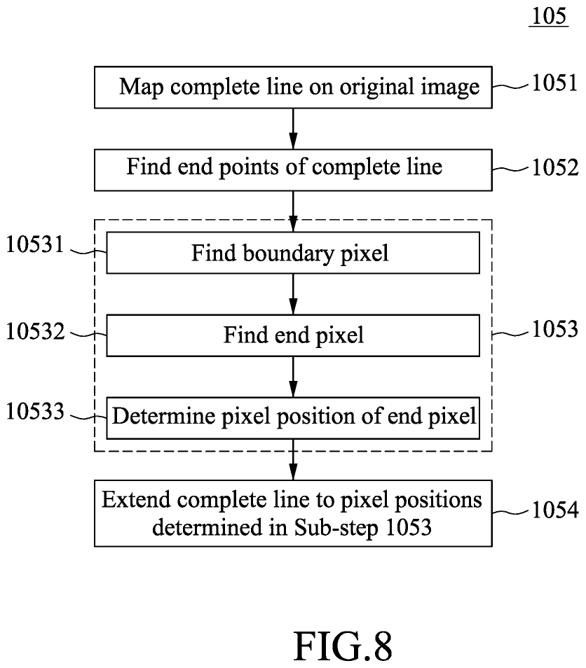

Step 105 is to generate a third processed image by extending the complete lines in the second processed image based respectively on the stick regions in the original image. It should be understood that the third processed image is also a binary image. The third processed image includes multiple extended lines that correspond respectively to the complete lines and also respectively to the stick regions in the original image, and that each have a length equal to a length of the corresponding one of the stick regions. The extended lines in the third processed image have the first pixel value, and the rest of the third processed image has the second pixel value. According to an embodiment, Step 105 may include Sub-steps 1051 to 1054, as illustrated in FIG. 8, that are to be performed with respect to each of the complete lines in the second processed image.

Referring to FIG. 8, Sub-step 1051 is to map the complete line on the original image. The complete line mapped on the original image would be completely included in the stick region that corresponds to the complete line.

Sub-step 1052 is to find or locate two opposite end points of the complete line that is mapped on the original image.

Sub-step 1053 includes three Sub-steps 10531 to 10533 that are to be performed with respect to each of the two opposite endpoints of the complete line. First, Sub-step 10531 is to find a pixel (referred to as “boundary pixel” hereinafter) on the original image that is located on an extension line which extends the complete line from the end point. The boundary pixel is a nearest pixel with respect to the end point that has the second pixel value.

Next, Sub-step 10532 is to find an end pixel on the original image that is located on the extension line and is a nearest pixel with respect to the boundary pixel that has the first pixel value.

At last, Sub-step 10533 is to determine a position (e.g., a set of pixel coordinates) of the end pixel (referred to as “pixel position” hereinafter).

Sub-step 1054 following Sub-step 1053 is to extend the complete line in the second processed image to the two pixel positions that are determined in Sub-step 1053 respectively for the two opposite end points of the complete line, so as to obtain the corresponding one of the extended lines to be included in the third processed image.

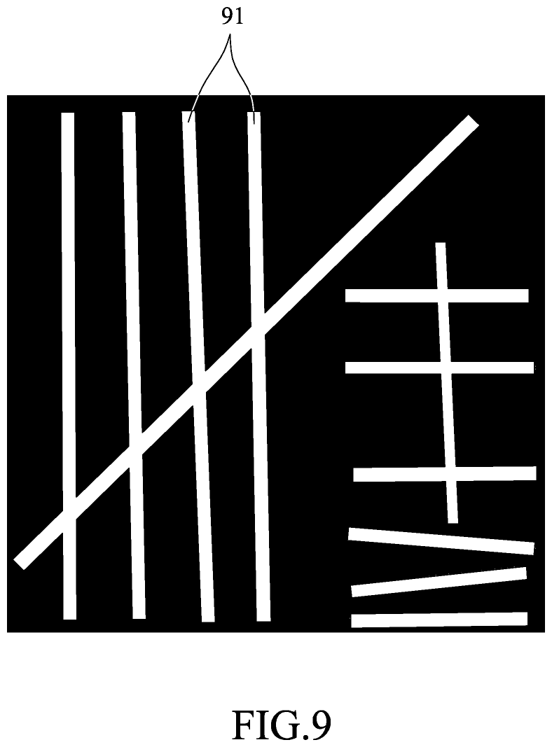

Returning to FIG. 1, Step 106 following Step 105 is to, for each of the extended lines in the third processed image, determine a rectangular region in the third processed image that covers the extended line, that has a length equal to a length of the extended line, and that has a width which is determined based on the corresponding stick region in the original image. The rectangular region thus determined for the extended line defines a wire region of the wire of the circuit that corresponds to the stick region, to which the extended line corresponds. FIG. 9 exemplarily illustrates an example of the third processed image that stems from the original image of FIG. 2 and that includes twelve rectangular regions 91.

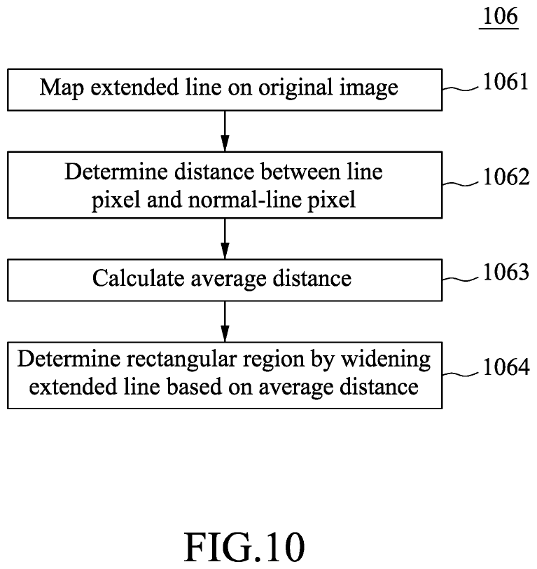

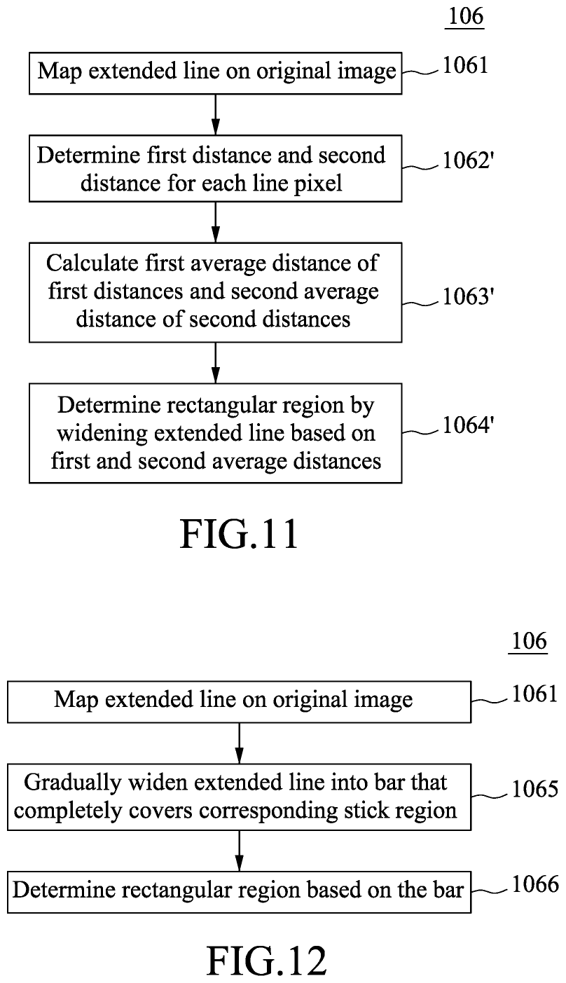

According to an embodiment, a first implementation of Step 106 may include Sub-steps 1061 to 1064, as illustrated in FIG. 10, that are to be performed with respect to each of the extended lines in the third processed image. According to another embodiment, a second implementation of Step 106 may include Sub-step 1061, 1062′, 1063′ and 1064′, as illustrated in FIG. 11, that are to be performed with respect to each of the extended lines in the third processed image. According to yet another embodiment, a third implementation of Step 106 may include Sub-steps 1061, 1065 and 1066, as illustrated in FIG. 12, that are also to be performed with respect to each of the extended lines in the third processed image.

Referring to FIG. 10 which illustrates the first implementation of Step 106, Sub-step 1061 is to map the extended line of the third processed image on the original image. The extended line mapped on the original image would be completely included in the stick region that corresponds to the extended line.

Sub-step 1062 is to, for each of multiple pixels (referred to as “line pixel” hereinafter) on the extended line that is mapped on the original image, determine a distance between the line pixel and one pixel on the original image that is located on a normal line passing through the line pixel and being perpendicular to the extended line (referred to as “normal-line pixel” hereinafter), wherein the normal-line pixel is a nearest pixel with respect to the line pixel that has the second pixel value. As such, multiple distances respectively for the multiple line pixels are determined. In an embodiment, said line pixels include all pixels on the extended line, but the disclosure is not limited thereto.

Sub-step 1063 is to calculate an average distance of the multiple distances determined in Sub-step 1062.

At last, Sub-step 1064 is to determine the rectangular region for the extended line of the third processed image by widening the extended line in both directions perpendicular to the extended line by the average distance calculated in Sub-step 1063. In this way, the rectangular region determined for the extended line has a length equal to the length of the extended line and a width equal to twice the average distance, and is centered on the extended line.

Referring to FIG. 11 which illustrates the second implementation of Step 106, it can be seen that the second implementation differs from the first implementation in that, in the second implementation, Sub-steps 1062′ to 1064′ are performed after Sub-step 1061 in place of Sub-steps 1062 to 1064 of the first implementation. Sub-steps 1062′ to 1064′ of FIG. 11 are similar to but slightly different from Sub-steps 1062 to 1064 of FIG. 10, and are described in detail as follows.

Sub-step 1062′ is to determine a first distance and a second distance for each of the multiple line pixels on the extended line that is mapped on the original image. The first distance is between the line pixel and a first pixel on the original image that is located on a first normal line passing through the line pixel and extending from the line pixel in a first direction perpendicular to the extended line. The first pixel is a nearest pixel with respect to the line pixel that is on the first normal line and that has the second pixel value. The second distance is between the line pixel and a second pixel on the original image that is located on a second normal line passing through the line pixel and extending from the line pixel in a second direction opposite to the first direction. The second pixel is a nearest pixel with respect to the line pixel that is on the second normal line and that has the second pixel value. As such, multiple first distances respectively for the multiple line pixels and multiple second distances respectively for the multiple line pixels are determined.

Sub-step 1063′ is to calculate a first average distance of the multiple first distances determined in Sub-step 1062′, and a second average distance of the multiple second distances determined in Sub-step 1062′.

Sub-step 1064′ is to determine the rectangular region for the extended line of the third processed image by widening the extended line in the first direction by the first average distance and in the second direction by the second average distance. In this way, the rectangular region determined for the extended line has a length equal to the length of the extended line and a width equal to the first average distance plus the second average distance, and has an orientation the same as the orientation of the extended line.

Referring to FIG. 12 which illustrates the third implementation of Step 106, the first Sub-step 1061 is the same as Sub-step 1061 of FIGS. 10 and 11 and is not repeatedly described here.

Sub-step 1065 that follows Sub-step 1061 in the third implementation is to gradually widen the extended line into a bar on the original image until the bar completely covers the stick region that corresponds to the extended line. According to some embodiments of the disclosure, the extended line may be gradually widened by one pixel or two pixels, but the disclosure is not limited thereto. According to some embodiments of the disclosure, in Sub-step 1065, whether the bar completely covers the stick region may be determined by determining whether a ratio of a number of pixels in the bar that have the first pixel value to a total number of the pixels in the bar is smaller than a predetermined percentage that is less than 100%. In an embodiment, the predetermined percentage is 95%, but the disclosure is not limited thereto.

At last, Sub-step 1066 is to make the region defined by the bar that completely covers the stick region the rectangular region for the extended line.

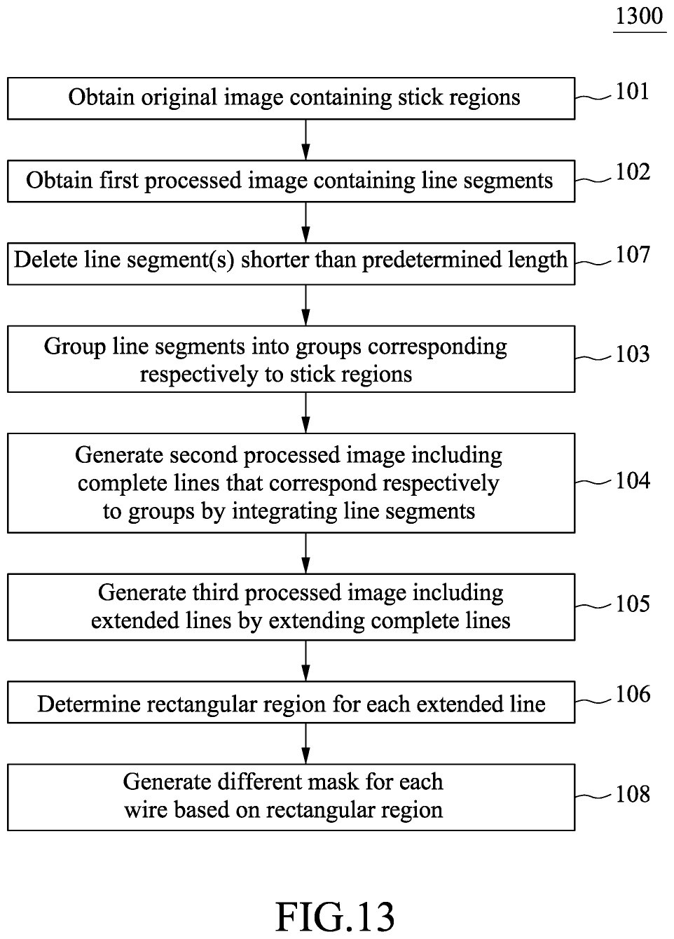

It should be noted that modifications may be made to the method 100 illustrated in FIG. 1 without going beyond the disclosure. For example, FIG. 13 exemplarily illustrates a method 1300 that is one of said modifications according to an embodiment of the disclosure.

As shown in FIG. 13, the method 1300 includes Steps 101 to 106 of the method 100 of FIG. 1, and further includes Step 107 that is to be performed between Steps 102 and 103, and Step 108 that is to be performed after Step 106. Specifically, first additional Step 107 is to delete any of the line segments in the first processed image that is shorter than a predetermined length by changing pixel values of pixels of the line segment from the first pixel value to the second pixel value. Any line segment that is shorter than a predetermined length is regarded as noise. In an embodiment, the predetermined length is 5 pixels, but the disclosure is not limited thereto.

Second additional Step 108 is to, for each of the wires of the layout of the circuit, generate a mask based on the rectangular region that is determined (in Step 106) for the extended line that corresponds to the stick region which corresponds to the wire. The mask thus generated for the wire may be used for inspection, e.g., defect detection, of the wire. Using the mask dedicated for the individual wire may increase efficiency of the inspection, and reduce possibility of overlooking defections.

It should be noted that it is not necessary for the two additional Steps 107 and 108 to coexist when implementing the present disclosure. According to some embodiments, one of Step 107 and Step 108 may be omitted from the method 1300.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for determining wire regions of a circuit, comprising steps of:
obtaining an original image that is a binary image and that contains multiple stick regions having a first pixel value and corresponding respectively to multiple wires of a layout of a circuit;
processing the original image to obtain a first processed image that is a binary image and that contains multiple line segments having the first pixel value and being obtained from the stick regions;
based on distances and included angles among the line segments, grouping the line segments into multiple groups that correspond respectively to the stick regions in the original image;
generating a second processed image based on the first processed image, the second processed image being a binary image and including multiple complete lines that have the first pixel value and that correspond respectively to the groups and respectively to the stick regions in the original image, each of the complete lines being constructed by integrating the line segments of the respective one of the groups into the complete line;
generating a third processed image by extending the complete lines in the second processed image based respectively on the stick regions in the original image, the third processed image being a binary image and including multiple extended lines which have the first pixel value, which correspond respectively to the stick regions in the original image, and each of which has a length equal to a length of the corresponding one of the stick regions; and
for each of the extended lines in the third processed image, determining a rectangular region in the third processed image that covers the extended line, that has a length equal to the length of the extended line, and that has a width which is determined based on the corresponding one of the stick regions in the original image.

2. The method of claim 1, further comprising a step of:
for each of the wires of the layout of the circuit, generating a mask based on the rectangular region that is determined for the extended line that corresponds to the stick region which corresponds to the wire.

3. The method of claim 1, wherein the step of processing the original image to obtain the first processed image includes sub-steps of:
performing image thinning on the original image to obtain a simplified image that includes a plurality of thinned lines obtained from reducing widths of the stick regions, respectively; and
performing Hough transform on the simplified image to obtain the line segments, so as to obtain the first processed image.

4. The method of claim 3, wherein the sub-step of performing Hough transform is to ignore line segments that are shorter than a length threshold.

5. The method of claim 1, further comprising a step, after the step of processing the original image and before the step of grouping the line segments, of:
deleting any of the line segments that is shorter than a predetermined length from the first processed image by changing pixel values of pixels of the line segment from the first pixel value to a second pixel value that is different from the first pixel value.

6. The method of claim 1, wherein the step of grouping the line segments includes following sub-steps, to be performed with respect to each different pair of the line segments that includes a first line segment and a second line segment, of:
calculating an included angle between two lines defined respectively by the first line segment and the second line segment;
comparing the included angle with an angle threshold;
determining a first distance between a first end point of the first line segment and the line defined by the second line segment, a second distance between a second end point of the first line segment and said line, and a third distance between a center point of the first line segment and said line;
comparing each of the first distance, the second distance and the third distance with a distance threshold; and
determining that the first line segment and the second line segment belong to a same group when the included angle is smaller than the angle threshold and when any two of the first distance, the second distance and the third distance are smaller than the distance threshold.

7. The method of claim 1, wherein the step of generating the third processed image includes following sub-steps, to be performed with respect to each of the complete lines in the second processed image, of:
mapping the complete line on the original image;
finding two opposite end points of the complete line that is mapped on the original image;
for each of the two opposite end points of the complete line,
finding a pixel on the original image that is located on an extension line which extends the complete line from the end point, that is a nearest pixel with respect to the end point, and that has a second pixel value which is different from the first pixel value,
finding an end pixel on the original image that is located on the extension line, that has the first pixel value and that is closest to the pixel thus found, and
determining a pixel position of the end pixel thus found; and
extending the complete line in the second processed image to the two pixel positions that are respectively determined for the two opposite end points of the complete line.

8. The method of claim 1, wherein the step of determining a rectangular region includes following sub-step, to be performed with respect to each of the extended lines in the third processed image, of:
mapping the extended line of the third processed image on the original image;
for each of multiple pixels on the extended line that is mapped on the original image, determining a distance between the pixel on the extended line and one pixel on the original image that is located on a normal line passing through the pixel and being perpendicular to the extended line, that is a nearest pixel with respect to the pixel on the extended line and that has a second pixel value which is different from the first pixel value;
calculating an average distance of the distances that are determined respectively for the multiple pixels; and
determining the rectangular region for the extended line of the third processed image by widening the extended line in both directions perpendicular to the extended line by the average distance thus calculated.

9. The method of claim 1, wherein the step of determining a rectangular region includes following sub-steps, to be performed with respect to each of the extended lines in the third processed image, of:
mapping the extended line of the third processed image on the original image;
for each of multiple pixels on the extended line that is mapped on the original image,
determining a first distance between the pixel on the extended line and a first pixel on the original image that is located on a first normal line passing through the pixel on the extended line and extending from the pixel on the extended line in a first direction perpendicular to the extended line, that is a nearest pixel with respect to the pixel on the extended line and that has a second pixel value which is different from the first pixel value, and
determining a second distance between the pixel on the extended line and a second pixel on the original image that is located on a second normal line passing through the pixel on the extended line and extending from the pixel on the extended line in a second direction opposite to the first direction, that is a nearest pixel with respect to the pixel on the extended line and that has the second pixel value;
calculating a first average distance of the first distances that are determined respectively for the multiple pixels, and a second average distance of the second distances that are determined respectively for the multiple pixels; and
determining the rectangular region for the extended line of the third processed image by widening the extended line in the first direction by the first average distance and in the second direction by the second average distance.

10. The method of claim 1, wherein the step of determining a rectangular region includes following sub-steps, for each of the extended lines in the third processed image, of:
mapping the extended line of the third processed image on the original image;
gradually widening the extended line into a bar on the original image until the bar completely covers the stick region corresponding to the extended line; and
determining the rectangular region for the extended line to be the region defined by the bar that completely covers the stick region.

11. The method of claim 10, wherein the sub-step of gradually widening the extended line includes:
determining whether the bar completely covers the stick region by determining whether a ratio of a number of pixels in the bar that have the first pixel value to a total number of the pixels in the bar is smaller than a predetermined percentage.
